(19) United States
(12) Patent Application Publication
(10) Pub. No.: US 2022/0142349 A1
(43) Pub. Date: May 12, 2022

(54) SMART ELECTRIC TOOTHBRUSH

(71) Applicant: ASTR INDUSTRIAL CO., LTD., Nanshan District (CN)

(72) Inventor: Susan Yang, Nanshan District (CN)

(21) Appl. No.: 17/094,830

(22) Filed: Nov. 11, 2020

(51) Int. Cl. A46B 15/00; A46B 11/00; A61C 17/22

(52) U.S. Cl. CPC A46B 15/0006; A46B 15/0044; A46B 2200/1066; A61C 17/221; A46B 11/002

(57) ABSTRACT

A smart electric toothbrush showing the results of brushing by determining the brushing posture, which includes a brush handle and a brush head mounted on the brush handle, a motor in the brush head driving the brush head to work, and a controlling component electrically connected to the motor. A posture detection unit is located in the brush head electrically connected to the controlling component, and the posture detection unit includes a three-axis gyroscope and a three-axis accelerometer. Roll and pitch angles of the smart electric toothbrush are detected by the posture detection unit, and a brushing section is determined by the controlling component by detecting a posture of brushing after complementary filtering the roll angle and the pitch angle. By matching the determined position to the 16 sections, the user can be alarmed that which section is missing or over-brushing.

### TECHNICAL FIELD

The present disclosure relates to a smart electric toothbrush, and particularly relates to a smart electric toothbrush showing the results of brushing by determining the brushing posture.

### BACKGROUND

People are paying more and more attention to oral health, which has led to more and more smart electric toothbrushes on the market. However, a conventional electric toothbrush can only be used for brushing teeth, and users may brush teeth in a certain section for too long without getting data feedback. Therefore, the users have no idea whether the brushing method is correct, what the result of brushing is, and how to using smart mode to automatically switch differ the vibration frequency in different brush sections to achieving a better effect. Thus, there's problems to be solved that, how to brush teeth effectively and reasonably, to analyze the brushing posture in real time, to understand the results of brushing teeth.

### SUMMARY

The present disclosure aims to solve one of the above technical problems at least to a certain extent. Accordingly, a smart electric toothbrush showing the results of brushing by determining the brushing posture is provided.

A smart electric toothbrush showing the results of brushing by determining the brushing posture, which includes a brush handle and a brush head mounted on the brush handle, a motor in the brush head driving the brush head to work, and a controlling component electrically connected to the motor. A posture detection unit is located in the brush head electrically connected to the controlling component, and the posture detection unit includes a three-axis gyroscope and a three-axis accelerometer. A roll angle and a pitch angle from Euler angles of the smart electric toothbrush are detected by the posture detection unit, and a brushing section is determined by the controlling component by detecting a posture of brushing after complementary filtering the roll angle and the pitch angle.

In a preferred embodiment, the brushing section includes a upper left section, a lower left section, a lower left inner section, an upper left inner section, a lower left outer section, an upper left outer section, an upper right section, a lower right section, a lower right inner section, an upper right inner section, a lower right outer section, an upper right outer section, an upper middle inner section, a lower middle inner section, an upper middle outer section, and a lower middle outer section.

In a preferred embodiment, the controlling component includes a circuit board provided in the brush handle, and a controlling switch mounted on the outside of the brush handle. The three-axis gyroscope is electrically connected to the circuit board.

In a preferred embodiment, the smart electric toothbrush further includes a liquid storage cavity that can be filled of liquid toothpaste, the liquid storage cavity is in communication with the brush head by a pipeline, and a driving component is located inside of the brush head, which drives the liquid toothpaste flowing into the brush head.

In a preferred embodiment, the driving component is an air pump, which drives the liquid toothpaste flowing into the brush head.

In a preferred embodiment, the smart electric toothbrush further includes an alarm unit electrically connected to the controlling component. The alarm unit can send out a voice alarm in a brushing process, the controlling component controls the voice alarm unit to sent out the voice alarm when one of the brushing section is missing.

In a preferred embodiment, the smart electric toothbrush further includes a music unit electrically connected to the controlling component. The frequency of the music played by the music unit is synchronized with the vibration frequency of the motor.

The present disclosure has at least one of following advantage effects:

The smart electric toothbrush determines the position of the toothbrush by calculating the angle of rotation and the horizontal angle. By matching the determined position to the above mentioned 16 sections, the user can be informed that which section is not brushed or over-brushing by sounds, figures, lights, texts, or an app, thereby helping the user to develop good brushing habits.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is an exploded view of a smart electric toothbrush of the present disclosure;

FIG. 2 is a perspective view of the smart electric toothbrush of the present disclosure;

FIG. 3 is a perspective view of the brushing sections of the present disclosure ;

FIG. 4 is a front view of the smart electric toothbrush of the present disclosure with a brushing results indicator light; and

FIG. 5 is a front view of the smart electric toothbrush of the present disclosure with the brushing results indicator light showing the Smart mode.

### DETAILED DESCRIPTION OF THE EMBODIMENTS

The present disclosure will be further described in detail below with reference to the drawings. However, the present disclosure can be implemented in many different forms and is not limited to the embodiments described herein. Rather, these embodiments are provided to provide a thorough understanding of the present disclosure.

Based on the embodiments of present disclosure, all other embodiments obtained by those of ordinary skill in the art without creative work shall fall within the protection scope of the present disclosure.

It should be noted that, all directional indications (such as up, down, left, right, front, back, inside, outside, center) in the embodiments of the present invention are only used to explain the relative positional relationship between the components, movement conditions, or the like in a specific posture (as shown in the accompanying drawings). If the specific posture changes, the directional indication will also change accordingly.

Unless defined otherwise, the term such as “fixed to ” or “connected to should be understood in broad sense. For example, when an element is referred to as being “fixed to” another element, it may be fixedly, detachably, or integrally connected on the other element; it may also be mechanically or electrically connected on the other element, and it may be directly on the other element or there may be a centered element. For those of ordinary skill in the art, the specific meaning of the above terms in the present disclosure may be understood according to the specific situation.

In addition, the technical solutions between the various embodiments of the present disclosure can be combined with each other, which must be based on what can be achieved by those of ordinary skill in the art. When the combination of technical solutions is contradictory or cannot be achieved, it should be considered that this combination of technical solutions does not exist and does not fall within the scope of protection claimed by the present disclosure.

### Embodiment 1

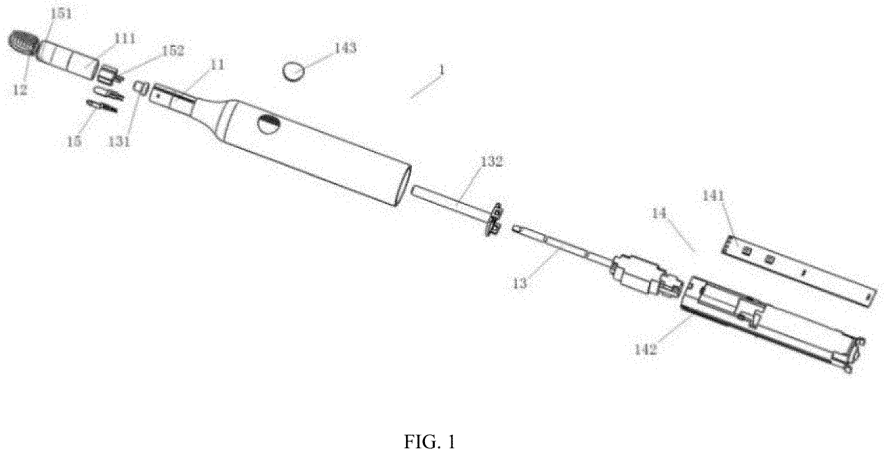

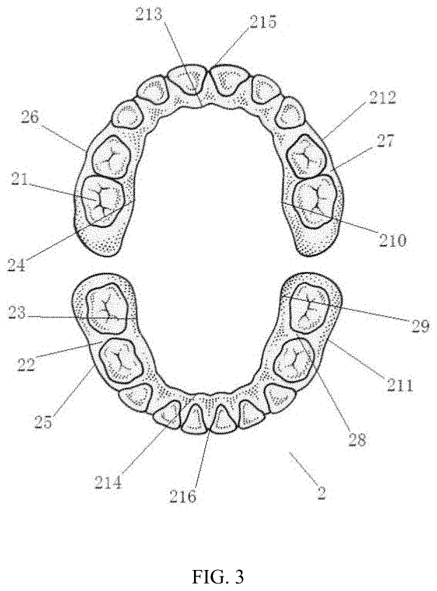

FIG. 1 shows a smart electric toothbrush showing the results of brushing by determining the brushing posture. First, the brushing area in one's mouth can be divided into several brushing sections 2 (FIG. 3), and the smart electric toothbrush of the present disclosure can automatically identify the specific brushing section in the current tooth-brushing situation. Specifically, the smart electric toothbrush 1 includes a brush handle 11 and a brush head 12 mounted on the brush handle 11. As the main structure of the smart electric toothbrush, the brush handle 11 can be used as a toothbrush handle, which is hollow inside and some electric components and motion components can be mounted in the hollow brush handle 11. The brush head 12 is a main functional part of the smart electric toothbrush 1, which clean the user's mouth by rotating the brush head 12. Accordingly, the brush handle 11 has a motor 13 in the brush head driving the brush head 12 to work, and a controlling component 14 electrically connected to the motor 13 inside the brush handle 11. The controlling component 14 controls the working status of the motor 13, and the brush head 12 is detachably attached to the brush handle 11. A waterproof gasket 131 is located between the brush handle 11 and the brush head 12, the waterproof gasket 131 can seal the end of the brush handle 11, so as to prevent the water or other liquid from flowing into the brush handle 11 from the brush head 12. The waterproof gasket 131 can be made of silicone, the output shaft of the motor 13 also has a motor cap 132, the output shaft extends out of motor cap 132, and the waterproof gasket 131 covers at the connection between the output shaft and the motor cover 132, forming a sealing structure.

Additionally, a three-axis gyroscope and an accelerometer electrically connected to the controlling component 14 are mounted inside of the brush handle 11. The three-axis gyroscope and accelerometer can determine the Euler angles of the toothbrush. Specifically, the Euler angles include a roll angle, a pitch angle, and a course angle. The accelerometer is a three-axis accelerometer, which calculates an actual coordinates of the XYZ axis (X axis is parallel to the brush handle, Y axis is perpendicular to the cross-sectional plane of the brush head, and Z axis is perpendicular to the plane where the X and Y axes are located). According to the XYZ axis coordinates, the pitch angle is calculated by the formula atan2(accY, accZ), and the roll angle is calculated by the formula atan(−accX/sqrt(accY×accY+accZ×accZ). Thus, the controlling component 14 determines the brushing posture by the calculated Euler angles. The controlling component 14 also has a filtering unit, which can filter the drift angle caused by the three-axis gyroscope by means of complementary filtering, so as to makes the calculated Euler angles more accurate. Specifically, the direction of the brush head can be judged by the roll angle, and the direction of the brush handle can be judged by the pitch angle. According to the data of the above mentioned pitch angle and roll angle, the specific brushing section where the brush head is located can be determined.

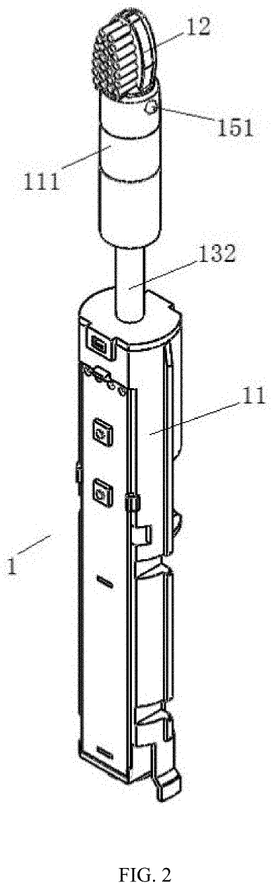

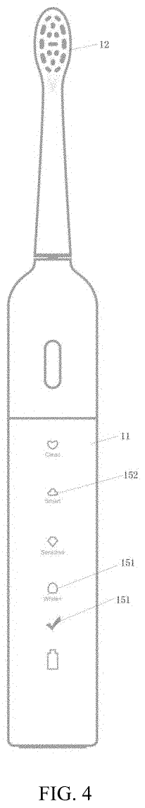

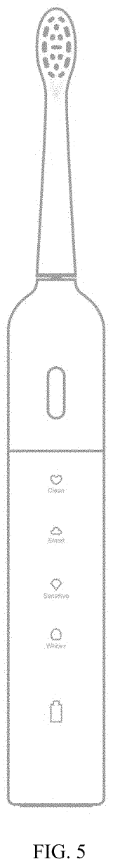

Specifically, referring to the illustrated embodiment of FIG. 2 to FIG. 4, the brushing section can be divided into 16 sections, which of the section is corresponding to a specific roll angle and a specific pitch angle. The 16 sections include a upper left section 21, a lower left section 22, a lower left inner section 24, an upper left inner section 23, a lower left outer section 25, an upper left outer section 26, an upper right section 27, a lower right section 28, a lower right inner section 29, an upper right inner section 210, a lower right outer section 211, an upper right outer section 212, an upper middle inner section 213, a lower middle inner section 214, an upper middle outer section 215, and a lower middle outer section 216. The above mentioned dividing method is based on the physiological structure of the oral cavity and divides the oral cavity into specific sections, and the angle range of the above mentioned 16 sections can be determined by the above pitch and roll angles. In a preferred embodiment, the smart electric toothbrush 1 also has an alarm unit, the controlling component 14 includes a processor, the processor can process the angles of the pitch and roll angles, thereby determining the corresponding brushing section 2. Also, referring to FIG. 4, the smart electric toothbrush also has a Smart mode switch 152, after pushing the switch 152, the main interface of the toothbrush is switched into the interface shown in FIG. 5. The processor can automatically adjust the vibration frequency of the motor 13 according to the current brushing section where the toothbrush 1 located. As shown in FIG. 3, due to the difference in the structure of the teeth, the surface of the incisor is flat with a small tooth tip and chewing area, and the molar has a large crown and several tips, and the surface is uneven, therefore generally, different vibration frequency can clean the teeth more effectively. Thus, in the Smart mode, the smart electric toothbrush 1 can automatically switch the frequency according to the brushing section, the vibration frequency of the motor 13 enhances or decreases, so as to achieve a smart tooth-brushing. Additionally, if one of the brushing section is missing, the alarm unit can send out the voice alarm to the user. The smart electric toothbrush 1 also has a music unit electrically connected to the controlling component 14, and the vibration frequency of the brush fiber of the brush head can be controlled by the music unit. Specifically, the frequency of music played by the music unit can control the vibration frequency of the brush fiber of the brush head, increasing the interactivity and enjoyment. Controlling the vibration frequency of the motor by the size of the sound belongs to the prior art, and will not be repeated here.

Preferably, the brush head 2 has a shell outside, and the shell can be mounted with a LED display and two brushing results indicator lights 151, the user can understand the results of brushing by the brushing results indicator lights 151. For example, considering a total points of 100 points, and 6.25 points are deducted if one of the brushing sections is forgotten to be brushed, then the brushing results indicator lights 151 emit green if the total points are above 80, emit yellow if the total points are ranging from 60 to 80, and emit 60 if the total points are below 60. To let the user understand the brushing results more clearly, the LED display of the present embodiment can display sections that are not brushed. In details, the LED display can show a figure of teeth (such as FIG. 3), and the sections that are not brushed are highlighted in different color, such that the user can understand the brushing situation more clearly and directly. In an alternative embodiment, the smart electric toothbrush also has a Bluetooth or Wi-Fi module, which can be connected to a terminal such as a cellphone, then the tooth-brushing results can be displayed on a cellphone App.

In the illustrated embodiment, the toothbrush also has a travel lock. When the travel lock is activated, all the buttons on the brush handle 2 will become invalid, which can effectively prevent accidental touches caused by carrying the toothbrush during travel.

To better judge the user's brushing time, a pressure sensor can be mounted on the brush head, when the tooth is not working, the value of the pressure sensor is 0 or a negative number. Since the brush head will abut the teeth to generate pressure, the user's brushing time can be judged according to the time when the value on the pressure sensor is greater than 0. Expending the application of the pressure sensor, the time of the tooth-brushing contacting the teeth can be determined by the pressure sensor, if the value of the sensor remains 0 or lower for more than 10 seconds, the smart electric toothbrush automatically shuts down, maximally enlarging the service life.

As an alternative solution to shut down the toothbrush, the user can shake the brush handle 2 after finishing brushing, and the three-axis accelerometer detects that the shaking frequency is much higher than the normal vibration frequency of the brushing body, and the three-axis gyroscope detects that the section corresponding to the detected roll and pitch angles doesn't belong to the 16 preset sections, it is determined that the toothbrush is not in the normal brushing results, and the smart electric toothbrush automatically shuts down, maximally enlarging the service life.

Referring to FIG. 1 and FIG. 2, the smart electric toothbrush 1 further includes a liquid storage cavity that can be filled of liquid toothpaste, the liquid storage cavity is in communication with the brush head 12 by a pipeline, and a driving component is located inside of the brush head, which drives the liquid toothpaste flowing into the brush head 12, supplying the toothpaste while brushing. The liquid toothpaste used in this embodiment has good permeability, so it has better cleaning performance and better flow conductivity than convectional toothbrushes, and will not cause pipeline blockage, and no more squeezing is required, greatly simplifying the process of brushing. The liquid storage cavity is detachable to the brush handle 11, such that is can be detached and refilled if the liquid storage cavity is run out of the liquid toothpaste. Preferably, the brush handle 11 can has a groove corresponding to the size of the liquid storage cavity, and the liquid storage cavity is placed on the groove. The sidewalls of the liquid storage cavity has two ports, and of the port is in communication with the brush head by connecting to the pipeline in the brush handle 11, and the other port is connected to a driving component. In the embodiment, the driving component is an air pump, which drives the liquid toothpaste in the liquid storage cavity flowing into the brush head 12. As a motion component, the air pump also has a pressure valve, which can adjust the pressure in the liquid storage cavity, so as to control the flowing speed of the toothpaste.

Referring to FIG. 1, preferably, a battery is located in the brush handle 11, and the motor 13 and the controlling component 14 are both electrically connected to the battery. The circuit board is electrically connected to the battery by the supply circuit, and the brush handle 11 also has a battery assembly mold 142, where the battery is assembled in the battery assembly mold 142.

Also preferably, the brush handle 11 can also has a charging coil electrically connected to the battery inside. A charging interface used to charge the battery in the brush handle 11 are also provided on the brush handle 11. Additionally, a controlling switch 143 is also mounted outside of the brush handle 11, the controlling switch 143 is electrically connected to the controlling component, so as to control the turn on/off of the toothbrush.

Preferably, the charging coil can be a wireless charging coil, which is eclectically connected to the battery. The toothbrush can be placed on a charging base which is located outside of the brush handle and electrically connected to the wireless charging coil, so as to get charged.

Preferably, the brush handle 11 includes a brush barrel, a brush cap, and a brush base. The brush cap and the brush base are both detachably mounted on the brush barrel, and the brush barrel, brush cap and brush base are sequentially spliced to form a cavity, where the components in the brush handle 11 are all located in. In the embodiments, the cavity can be divided into several spaces by plastic partition plates, such that the controlling component 14 and the motor 13 is mounted in one of the spaces, the liquid storage cavity, the air pump are respectively mounted in other two spaces, and the battery is mounted in yet another space.

The specific embodiments are only explanations of the present disclosure, and the embodiments are not intended to limit the present disclosure. The scope of this present disclosure is not limited to the content of the description, and its technical scope shall be determined according to the scope of the claims. Such that the protection scope of the present disclosure should be subject to the claims.

What is claimed is:

1. A smart electric toothbrush, comprising a brush handle and a brush head mounted on the brush handle, a motor provided in the brush head driving the brush head to work, and a controlling component electrically connected to the motor, wherein a posture detection unit is provided in the brush head electrically connected to the controlling component, and the posture detection unit comprises a three-axis gyroscope and a three-axis accelerometer; a roll angle and a pitch angle from Euler angles of the smart electric toothbrush are detected by the posture detection unit, and a brushing section is determined by the controlling component via detecting a posture of brushing after complementary filtering the roll angle and the pitch angle.

2. The smart electric toothbrush according to claim 1, wherein the brushing section comprises a upper left section, a lower left section, a lower left inner section, an upper left inner section, a lower left outer section, an upper left outer section, an upper right section, a lower right section, a lower right inner section, an upper right inner section, a lower right outer section, an upper right outer section, an upper middle inner section, a lower middle inner section, an upper middle outer section, and a lower middle outer section.

3. The smart electric toothbrush according to claim 1, wherein the controlling component comprises a circuit board provided in the brush handle, and a controlling switch mounted on an outside of the brush handle, and the three-axis gyroscope is electrically connected to the circuit board.

4. The smart electric toothbrush according to claim 1, further comprising a liquid storage cavity being capable of being filled of liquid toothpaste, wherein the liquid storage cavity is in communication with the brush head via a pipeline, and a driving component is provided inside of the brush head, and the driving component drives the liquid toothpaste flowing into the brush head.

5. The smart electric toothbrush according to claim 4, wherein the driving component is an air pump, and the air pump drives the liquid toothpaste flowing into the brush head.

6. The smart electric toothbrush according to claim 1, further comprising an alarm unit electrically connected to the controlling component, wherein the alarm unit send out a voice alarm in a brushing process, the controlling component controls the voice alarm unit to sent out the voice alarm when one of the brushing section is missing or over-brushing.

7. The smart electric toothbrush according to claim 1, further comprising a music unit electrically connected to the controlling component, wherein a frequency of music played by the music unit is synchronized with a vibration frequency of the motor.

8. The smart electric toothbrush according to claim 1, further comprising a brushing results indicator light provided at the outside of the brush handle, wherein the brushing results indicator light shows lights, figures, or texts, and the brushing results indicator light shows the results of brushing according to the brushing posture and the brushing section.

9. The smart electric toothbrush according to claim 2, further comprising a brushing results indicator light provided at the outside of the brush handle, wherein the brushing results indicator light shows lights, figures, or texts, and the brushing results indicator light shows the results of brushing according to the brushing posture and the brushing section.

10. The smart electric toothbrush according to claim 1, wherein the brush handle is provided a Smart mode, and a vibration frequency of the motor in the Smart mode is automatically switched according to the different brushing section.

11. The smart electric toothbrush according to claim 2, wherein the brush handle is provided a Smart mode, and a vibration frequency of the motor in the Smart mode is automatically switched according to the different brushing section.

12. The smart electric toothbrush according to claim 1, wherein the smart electric toothbrush is capable of automatically shutting down via determining a swing frequency and an angle of the brushing posture.
